(19) United States
(12) Patent Application Publication
(10) Pub. No.: US 2008/0118336 A1
(43) Pub. Date: May 22, 2008

(54) Picking assist mechanism

(76) Inventor: Howard McIlvaine, Freehold, NJ (US)

Correspondence Address: MICHAEL I. CHAKANSKY, LAW OFFICES OF MICHAEL I. CHAKANSKY, 56 STUART PLACE, ORADELL, NJ, 07649, US

(21) Appl. No.: 11/983,966

(22) Filed: Nov. 13, 2007

Related U.S. Application Data
(60) Provisional application No. 60/866,153, filed on Nov. 16, 2006.

(51) Int. Cl. B65G 1/10; B65G 65/02

(52) U.S. Cl. 414/280; 414/285

(57) ABSTRACT

An ergonomic mechanism is provided for storage facilities eliminating the need to reach into a storage shelf, or tier, to access rear situated packages. The mechanism of the invention comprises a manually movable pusher/puller that engages items/packages disposed at the back of the storage shelf. The pusher/puller is manually pulled forward by flexible connectors, causing the rear packages to move forward upon the flow tracks until they reach the front area of the tier and engage a picking shelf. At the front, packages can be picked from the tier with ergonomic ease due to the flexible connectors that allow movement of a gripping handle in any direction with respect to the shelf.

### RELATED APPLICATION

This application claims priority to the Provisional Application filed on Nov. 16, 2006; having application No. 60866153; entitled: PICKING ASSIST MECHANISM, First named Inventor: Howard McIlvaine.

### FIELD OF THE INVENTION

The present invention relates to the storage and retrieval arts, and more particularly to a manual, ergonomic, picking assist mechanism for easily picking packages and items from the tier of a storage facility/warehouse. Storage tier position can contain multiple items stored in a predetermined array and multiple rows. This invention allows the items to be transferred from the pallet to the storage tier position. Furthermore the invention, through a mechanical assembly, allows the items to be picked from the front position of the storage tier. This eliminates the need for the picker to reach into the rear confines of the storage tier in order to pick the item.

### BACKGROUND OF THE INVENTION

In storage facilities, or warehouses, the picking of items/product from storage positions has always posed problems for the package handlers. Bulk storage positions are generally flat, and rear situated packages are not easily accessible. Even where shelving is designed with a slight incline, and with roller assisted flow tracks, rear packages (particularly heavy items) will often hang-up upon the feed rollers. These packages will remain in back of the shelving where they cannot be easily accessed, or picked. Additionally these tier designs require more storage space per item than bulk storage. Therefore, there has existed a long felt need to improve the process of picking from bulk storage by eliminating the need to reach into a storage tier in order to access items/packages situated within the storage tier.

In the prior art most of the bulk storage is on pallets. The majority of pallets are generally loaded with multiple units of the same type item and packaging. These items are typically arranged on the pallet in cube—linear columns and rows. Through the use of standard equipment, i.e. forklifts, jacks, etc., the pallet is brought to the storage position, and the items, packages, or products are transferred into the storage tier. To fill the orders pickers will travel to the appropriate storage position, and pick the item/product from the pallet. The items are manually picked in a sequence beginning with the top item on the pallet to the bottom and from the front item to the back. This requires additional effort to pick these items/packages from these positions, which takes more time to pick and puts additional strain on the picker. This picking procedure is labor-intensive, and requires expenditure of physical energy. The effort quickly drains the pickers of energy. They function at reduced physical and mental capacity. Therefore, there has existed a long felt need to change this system.

In United States Patent Publication No. US 2006/0051187 A1, published on Mar. 9, 2006, to Bell, for: SYSTEM AND METHOD FOR HANDLING STOCKED ITEMS, an automatic stocking system, is shown. The automatic, electrically operated system features a repositioning assembly that can be automatically controlled by a sensor. The automated system based upon feedback from the sensor changes the position of the items automatically from rear to front.

In United States Patent Publication No. US 2006/0204354 A1, published on Sep. 14, 2006, to Sonon et al. for: STORAGE SYSTEM AND METHOD, manual and automatic systems are described for positioning or repositioning objects upon a storage support. The systems rely upon the sensing of a package or item at a forward position of the storage support. A manual system which is also described therein, has one to three arms that pull upon a pusher plate. The arms are rigid rods that travel through sleeve bearings mounted in the frame, and whose restricted forward movement is provided by pulling upon a handle disposed at the front of the storage support. The support surface is described as a low friction material, such as PTFE, or nylon in order to facilitate movement of the packages upon the tier.

One of the drawbacks of the described system is the rigid rods that influence the pusher. The rigidity of the rods restricts the handle to linear movement in a pulling plane. Thus, support surfaces that are positioned above a normal height of the operator, greatly impair the ability of the operator to easily access and control the movement of the pusher by use of the handle. This in turn produces strain upon the operator and the sleeve bearings.

Another serious drawback of the aforementioned system is the need for low friction nylon or PTFE supports which with time wear or become fouled by dusts and debris. The overall operation of the system described in the publication also requires additional supporting rails to prevent packages from sliding off the storage support surface. These rails additionally require friction proofing with PTFE or nylon.

The present invention seeks to provide a manual mechanism, which allows pickers to ergonomically access packages/items situated within the storage tier.

Current storage positions can be modified to include the inventive mechanism, or the inventive mechanism can be manufactured as part of the picking tier frame/structure.

The current invention provides a mechanism that will receive items/packages from a pallet and allow a package handler to easily pull packages located within the storage tier to a slide/pick plate located at the front of the tier. Once positioned at the front of the tier, the items/packages can be easily picked and carried away.

The present invention comprises a pusher, i.e. a push plate or other generally inelastic material that is movable upon a pair of linear guides, for example: rods, tracks, rails, cables, etc. The pusher can also be considered as a “puller” in that when pulled upon, it pushes/pulls items/packages along with it in the direction of the pulling action.

In the case where the linear guides are a pair of rails, they are each generally located on opposite sides of the tier. Ball races disposed on each side of the pusher/puller supports and guides the pusher/puller upon the guide rails with sliding motion. Thus the pusher/puller can easily move back and forth across the tier. Flow tracks disposed upon the top surface of the tier further enhance the movement of the items/packages.

The front of the end beam of the picking tier frame supports a handle that can be gripped, and pulled outwardly from the tier frame in every direction in the pulling plane, i.e. up or down. The handle is attached to the pusher/puller by flexible connectors that can comprise cables, chains, etc. The flexible connectors pass through the end beam to connect with the handle, by means of apertures that can comprise ball races to reduce friction. Pulling on the handle causes the pusher/puller plate to move forwardly towards the picking plate located at the front of the tier. The handle is usually a given span across the end beam, which is needed to connect to the flexible connectors. It can also be further elongated across the length of the end beam to provide a larger gripping surface. The handle placement is designed to provide the least interference with arriving or departing vehicles, such as fork lifts, hand trucks, dollies, etc. The handle, therefore, is designed to be flush with the surface of the end beam, or to rest within a recess in the end beam surface.

It is important to note, that the height relative to the support surface may be above or below the reach of a picking operator. The present invention features the flexible connectors in order that the picker can pull the pusher/puller from a height that is not necessarily in the tier plane. The flexibility of the connectors provide for the handle to be pulled upwardly or downwardly without detracting from the translational movement of the pusher plate. Once at the front, the packages can be easily picked and carried away. This feature provides increased ergonomic access.

In addition, the pusher is guided along guide rails through ball races that provide frictionless operation. The guide rails prevent cocking of the pusher plate to either side, as may happen should a greater pulling force be exerted between left and right flexible connector cables.

The pusher is attached to a draw cable wound within a spring reel. The spring reel is fixed to the back end beam beneath the undercarriage of the tier. The draw cable of the spring reel is withdrawn when the elongated handle of the forward end beam is pulled out. The spring reel provides tension upon the handle cable connectors as the pusher is drawn forward. Releasing the handle will cause the pusher to return to its original position under the biasing of the spring reel. The cables attached to the handle automatically withdraw into the apertures. The elongated handle is caused to fit flush or in a recess within the front of the forward end beam, when the spring reel cable is fully wound within the spring real housing.

An alternate embodiment to the biasing spring reel can be a coil spring that is disposed within each guide rod. Movement of the pusher along the guide rods is biased by the internal springs, forcing the pusher back to its original position at the rear of the storage support tier.

The invention also features flexible, tier located, bumpers to safeguard the handle and pulling mechanism.

### DISCUSSION OF RELATED ART

Product/items disposed on storage tiers that are flat, or inclined, have access problems. Delivering the packages to the front of the tier has always presented difficulties for package handlers. At present, to the best of the knowledge of the inventor, the only two mechanisms that will presently provide a means by which packages disposed along the tier can be accessed without reaching inside the tier, is the expensive automated system, as described in the afore-mentioned publication, U.S. Pub. No. U.S. 2006/0051187 A1; and the problematic manual system suggested in U.S. Publication No. US 2006/0204354 A1. These systems have many drawbacks as previously mentioned.

The present invention seeks a simpler, more reliable system, in which energy costs are nil and non-existent. The invention seeks an uncomplicated mechanism that is inexpensive, ergonomically correct, easily installed and easily operated to provide reliability.

Publication No. US 2006/0204354 A1 illustrates a manual and automated system for picking packages from a storage tier. A handle is attached to inflexible rods that are attached to a pusher. The surfaces supporting the packages are coated with friction-reducing materials, e.g. PTFE and nylon.

One of the drawbacks of the described system is the rigid rods that influence the pusher. The rigidity of the rods restricts the handle to linear movement in a pulling plane. Thus, support surfaces that are positioned above or below a normal height of the operator, greatly impair the ability of the operator to easily access and control the movement of the pusher by use of the handle. This in turn produces strain upon the operator and the sleeve bearings, and is not ergonomically correct. Furthermore, the handle is not shielded from interference with forklift trucks and other vehicles delivering or receiving items/packages to the tier.

Another serious drawback of the aforementioned system is the need for low friction nylon or PTFE supports which with time wear or become fouled by dusts and debris. The overall operation of the system described in the publication also requires additional supporting rails to prevent packages from sliding off the storage support surface. These rails additionally require friction proofing with PTFE or nylon.

### SUMMARY OF THE INVENTION

In accordance with the present invention, a manually operated, ergonomic mechanism and method are provided for a storage facility/warehouse that eliminates the need to reach into a storage tier in order to access rear situated items/packages. The present invention receives items/packages from a loaded pallet. The pallet is transported to the storage tier via standard equipment, such as: forklifts, dollies, etc. Items/packages are pushed from the pallet and transferred to the storage tier en mass, thus initially contacting the slide/pick plate, and subsequently feed rollers of flow tracks. As the items/products are transferred into the storage tier via the feed rollers, they approach the end of the storage tier where they contact the pusher/puller member. The pusher/puller member acts as a back stop, which prevents the items/packages from being pushed beyond the storage tier.

Bumpers mounted to the front end beam or frame, absorb the shocks of loading impacts caused by fork lift vehicles. The pusher/puller mechanism, i.e. including the pusher/puller member, guide rails, flexible connectors, and handle, can be situated level or inclined with respect to the storage tier, depending upon functional requirements.

The manual mechanism of the invention comprises a movable pusher/puller plate that is movable upon a pair of linear guide rails disposed on each side of the tier. The movement of the pusher/puller is biased to a rear, rest position of the tier. The pusher/puller plate rides upon ball races as it traverses its guide rails. The pusher/puller plate is manually pulled forward by flexible, spaced-apart connectors each attached to the pusher/puller plate. Forward movement of the pusher/puller plate causes rear items/packages to move upon the flow tracks disposed upon the tier. The items/packages move along the flow tracks until they reach the front, slide/picking plate of the tier. At the front slide/picking plate, packages can be easily picked from the tier. The slide/pick plate is mounted slightly over, or upon the end of the flow tracks, and stops the items/packages from moving past the front, picking position.

The guide rails can comprise guide rods. The guide rods are each located on opposite sides of the picking tier. The ball races respectively provide sliding support on each side of the movable pusher as the pusher/puller plate glides over the guide rods. This allows the pusher/puller plate to easily move back and forth across the flow tracks.

The front of the forward, end beam of the picking tier carries an elongated handle. The handle fits flush upon, or recessed within, the front surface of the forward end beam, so it will not interfere with mechanized vehicles and fork lifts. The handle is easily gripped and pulled from the beam surface. The handle is attached to the pusher/puller plate via a pair of flexible handle connectors that can comprise cables, chains, etc. Pulling the handle outwardly in any direction, whether up, down, sideways, or straight outwardly causes the flexible handle connectors to be drawn forwardly through apertures disposed in the front of the forward end beam. In so moving, the handle cables pull upon the pusher/puller plate, forcing it towards the front of the picking tier. Packages disposed upon the rear of the flow tracks are caused to move forwardly as the pusher/puller plate engages them. Once moved to a forward picking plate, the packages are easily picked from the front of the picking shelf.

The pusher is attached to, and is biased by, a spring reel, or other biasing means, such as a spring-loaded scissor, or internal coil springs disposed in the guide rods housing. The spring reel has a cable that is attached to the pusher on the undercarriage of the tier. The housing of the spring reel is fixed to the rear end beam. The spring reel provides tension upon the handle cables and elongated handle, as the cable of the spring reel is drawn forward. Releasing the handle will cause the biased pusher/puller plate to return to its original position, and the handle cables to be automatically withdrawn back through the apertures. The elongated handle is caused to fit flush, or within its recess in the front of the forward end beam, as the handle connectors are fully withdrawn.

It is one object of this invention to provide a manual system for ergonomically accessing generally inaccessible storage items from a storage tier in a warehouse or storage facility.

It is yet another object of the invention to provide a simple, manually operated mechanism for causing rear situated items or packages disposed upon a storage tier in a warehouse or storage facility to be forced forward towards the front of the tier, where they can be easily accessed and picked.

It is a further object of this invention to provide a simple means for manually operating a pusher from a rest position, to an operative picking position, in order to cause rear situated items or packages to move forward upon a tier of a storage facility or warehouse.

It is yet another object of this invention to provide a manually operated system for accessing items or packages disposed en mass from a pallet, or other forklift carrying mechanism, upon the tier of a storage facility or warehouse, and allow pack handlers to easily access the items or packages located at the rear of the tier.

It is still another object of the invention to provide a manually operated, package accessing mechanism for a warehouse or storage facility, which can be cheaply purchased, easily installed, and ergonomically operated at minimum cost.

### BRIEF DESCRIPTION OF THE DRAWINGS

A complete understanding of the present invention may be obtained by reference to the accompanying drawings, when considered in conjunction with the subsequent detailed description, in which:

FIG. 1 illustrates a front perspective, partial schematic in situ, view of the picking assist mechanism of this invention as installed upon a storage tier of a warehouse or storage facility, as shown in its rest position “A”;

FIG. 2 depicts a front, perspective, partial schematic, in situ, phantom view of the picking assist mechanism of FIG. 1, in its operative picking position “B”. The phantom figure shows a package that was previous situated in the middle of the flow track, and has now been brought forward by the pusher/puller plate of the picking assist mechanism. The package is now resting on the slide/picking shelf at the front of the storage tier;

FIG. 3 shows a schematic, in situ view of a spring reel and extended spring reel cable situated in the undercarriage of the tier in the operative position “B” of FIG. 2;

FIG. 4 illustrates a partial side view of the picking assist mechanism in position “A”, as shown in FIG. 1;

FIG. 5 depicts a partial side view of the picking assist mechanism in position “B”, as shown in FIG. 2; and

FIG. 6 illustrates a partial side view of a tier of a storage facility having a bumper guard for protecting the elongated handle shown in FIGS. 1 and 2.

### DESCRIPTION OF THE PREFERRED EMBODIMENT

Generally speaking, a mechanism is provided for a storage facility or warehouse that allows ergonomic access to stored packages or items. The need to reach into a storage tier in order to access rear situated packages or items, is eliminated. The mechanism of the invention comprises a manually operated, movable pusher/puller plate that engages the packages or items disposed at the back of the storage tier. The pusher is manually pulled forward by a pair of flexible connectors attached to a handle. Pulling the handle in any direction causes the rear packages or items to move forwardly upon flow tracks until they reach the front of the storage tier. At the front, packages or items can be easily picked from the tier shelf comprising a slide/pick plate.

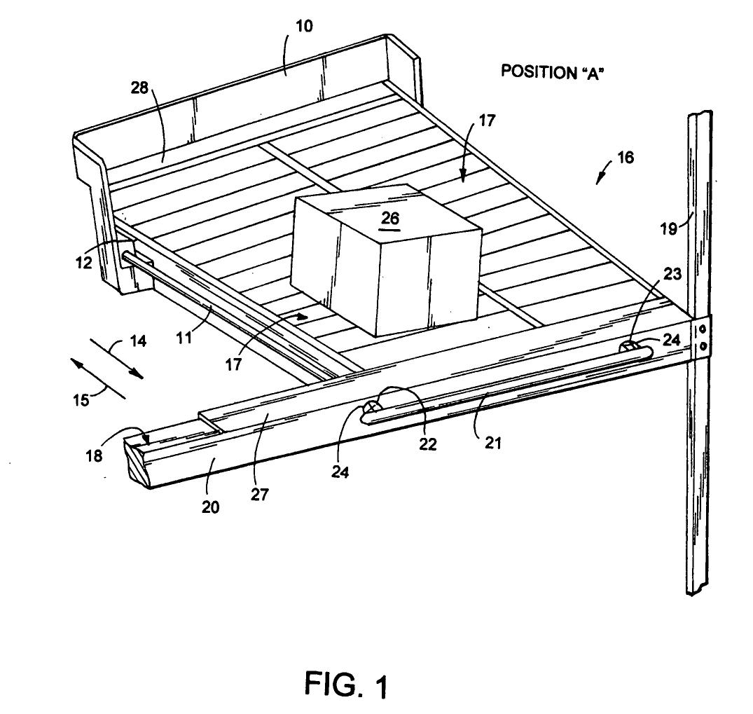

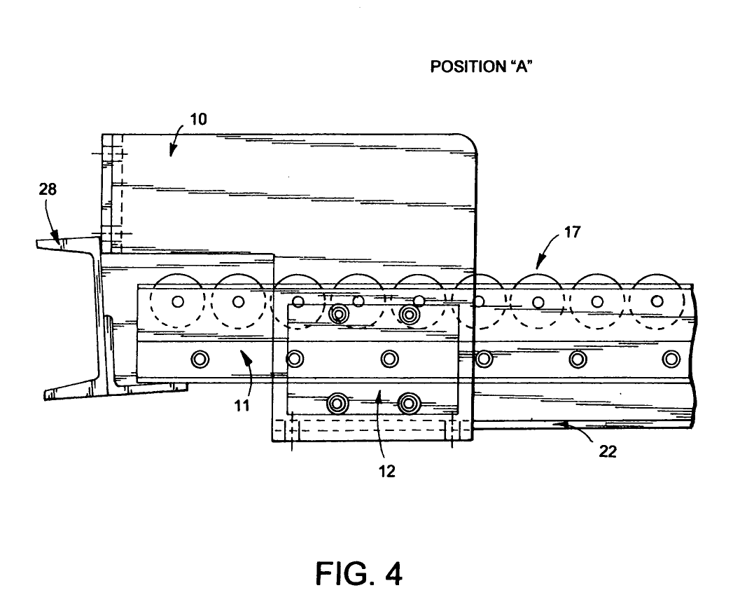

Now referring to FIGS. 1 and 4, a partial, in situ, perspective and side, schematic views of the manually operated mechanism of the invention, are illustrated. The mechanism comprises a pusher/puller plate 20, illustrated in its rest position “A”. The pusher/puller plate 10 is movable upon a pair of guide rods 11 (only the left guide rod is shown). The guide rods 11 are each located on opposite sides of the tier 16. A pair of ball races 12 supporting each side of the movable pusher/puller plate 10 slide upon the guide rods 11, as shown by arrows 14 and 15. This allows the pusher plate 10 to easily move back and forth across the flow tracks 17. The tier 16 is comprised of a forward end beam 18, a rear end beam 28, and vertical supports 19 (only one of which is shown).

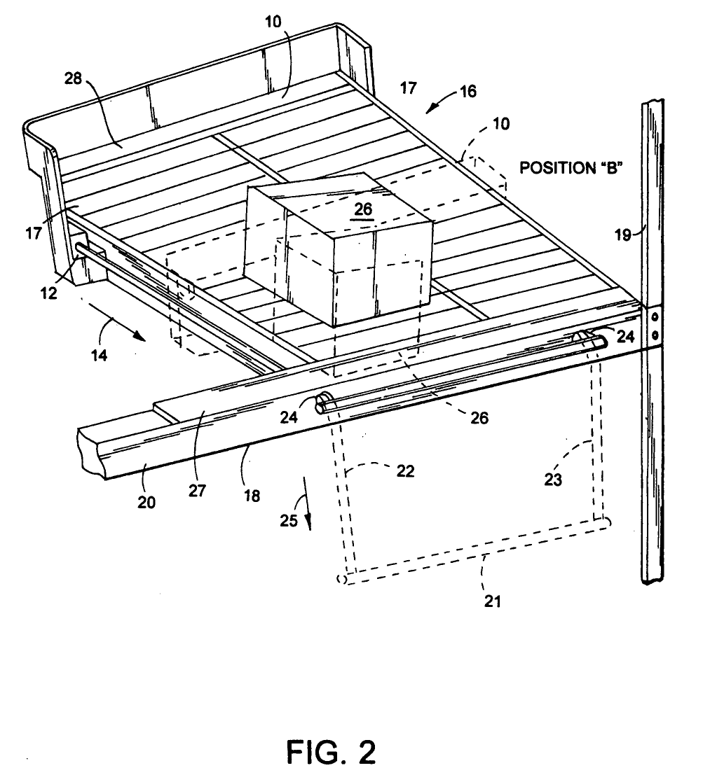

The front 20 of the forward end beam 18 carries an elongated handle 21 that is of sufficient length to span the points of connection to the flexible connectors 22 and 23, respectively. The flexible connectors 22 and 23 can comprise cables, chains, etc. The handle 21 fits flush, or is recessed along the front of the forward end beam 18, so it will not interfere with mechanized vehicles and fork lifts. The handle 21 is easily gripped and pulled in any direction from the front beam surface 20, as shown in FIG. 2 (arrow 25). The elongated handle 21 is attached to the pusher/puller plate 10 via the pair of flexible handle connectors 22 and 23, respectively, each of which project through apertures 24, as illustrated.

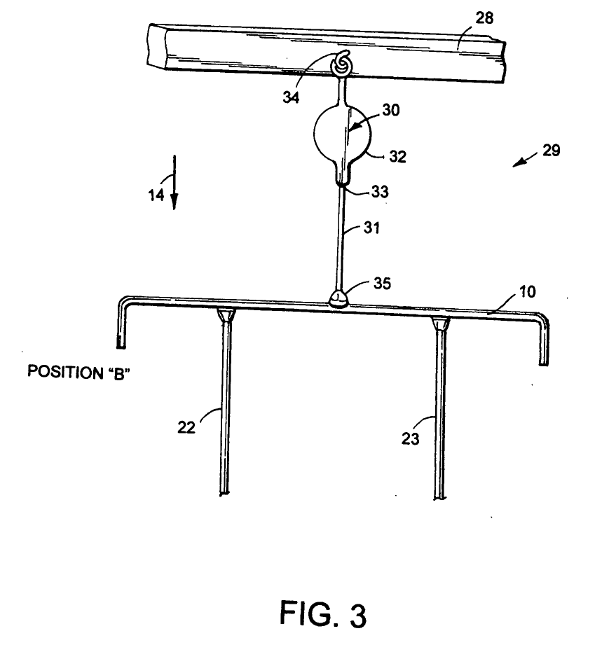

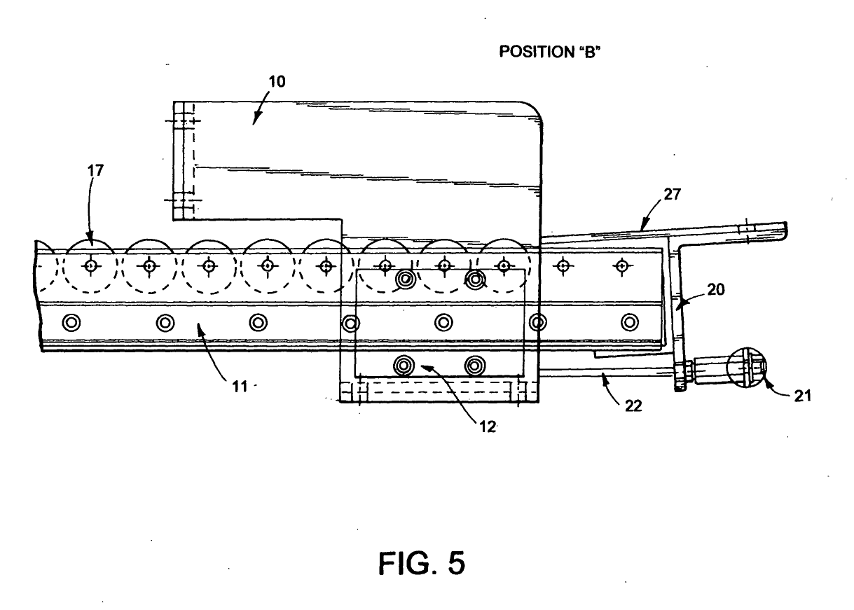

Referring to FIGS. 2 and 5, the pusher/puller plate 10 is shown in its operative position “B” (FIG. 2 illustrated partially in phantom view). Pulling outwardly in any direction, i.e. straight out, down, up, sideways, etc., upon the elongated handle 21 (See arrow 25) causes the flexible handle connectors 22 and 23 to be drawn through apertures 24 disposed in the front 20 of forward end beam 18. In so moving, the respective handle connectors 22 and 23 pull upon the pusher/puller plate 10 to which they are attached (see FIG. 3), forcing the pusher/puller plate 10 forward towards the front of the picking tier 16. The package 26 disposed in the middle of the flow track 17 (FIG. 1) is now caused to move forwardly as shown by arrow 14, as the pusher/puller plate 10 engages the package 26, illustrated in phantom. Once moved forwardly, the package 26 is easily picked from the picking shelf 27 disposed on top of the forward end beam 18. The picking shelf 27 comprises a slide/picking plate disposed over or slightly above the flow track 17. Thus, it is ergonomically possible to access packages situated deep within the tier 16 by pulling the handle 21 in any direction.

It should be observed, that the pusher/puller plate 10 also functions as a backstop for packages and items delivered to the storage tier 16. Thus, packages or items delivered by forklift or jacks to tier 16 cannot be pushed off the back of the tier 16.

Referring to FIG. 3, undercarriage 29 of the tier 16 is shown. A spring reel 30, manufactured by Coilhose Pneumatics Company, model No. BL 10 is attached to rear end beam 28 at hook 34. The spring reel 30 houses a spring reel cable 31. The spring reel cable 31 is internally carried within housing 32, and is extendable from the housing 32 through aperture 33. The spring reel cable 31 is influenced by an internal spring (not shown), which causes the spring reel cable 31 to retract into housing 32, when an extracting force (arrow 14) is released. An equivalent biasing mechanism can be a spring-loaded scissor mechanism, or a pair of internal coil springs disposed on opposite sides of the guide rod housing.

The spring reel cable 31 is attached to pusher/puller plate 10 at a rear section attachment point. Pulling upon flexible handle cables 22 and 23 (arrow 14) via handle 21 (FIGS. 1 and 2), extends the spring reel cable 31, and pusher/puller plate 10, to operative position “B”, as shown. Releasing the handle 21 will cause the spring reel cable 31 to retract back into housing 32 of the spring reel 30, and pusher/puller plate 10 to return to rest position “A” shown in FIGS. 1 and 4.

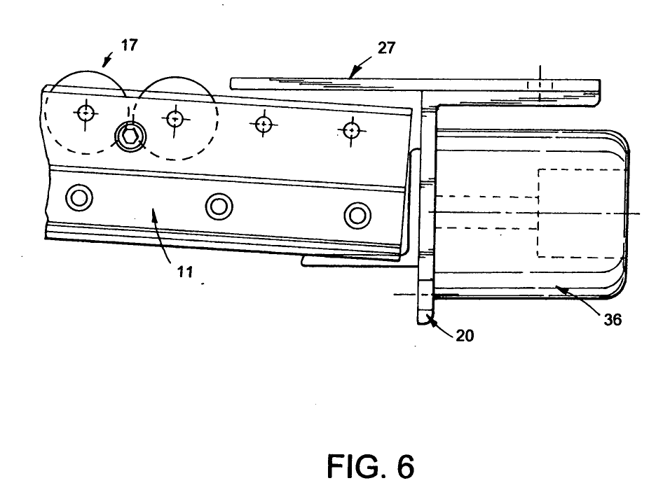

Referring to FIG. 6, a side, partial view of the front of tier 16 is shown. A bumper 36, generally comprised of hard rubber or other shock-absorbing material, is attached to the front beam surface 20 of the front, end beam 18. The bumper has its purpose to cushion shocks from forklifts and jacks.

The mechanism of this invention can be manufactured as original tier equipment for storage facilities, or an existing storage tier can be easily modified to include the inventive mechanism, with just a few modifications.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired for protection by Letters Patent is presented in the subsequently appended claims.

What is claimed is:

1. A picking assist mechanism for storage facilities comprising a tier having flow tracks for supporting and delivering items/packages to a front picking shelf, comprising:
an item engaging pusher/puller mechanism disposed at a rear portion of said tier for forcing items/packages at a rear portion of said tier into moving forwardly towards said front picking shelf, said pusher/puller mechanism including a pusher/puller member which is forced forward, and then returned by said pusher/puller mechanism to a rest position at said rear portion of said tier;
at least one flexible connector operatively attached to said item engaging pusher/puller member; and
a manually operated handle disposed adjacent to said picking shelf and operatively attached to said item/package engaging pusher/puller member via said at least one flexible connector, said handle when pulled in any direction with respect to said front picking shelf, forces said item/package engaging pusher/puller member into engaging contact with an item/package disposed upon said flow tracks.

2. The picking assist mechanism in accordance with claim 1, wherein said item/package engaging pusher/puller member comprises a movable pusher/puller plate disposed along said flow tracks of said tier for engaging with, and forcing, items/packages disposed at a rear portion of said flow tracks into moving forwardly towards said picking shelf.

3. The picking assist mechanism in accordance with claim 1, wherein said pusher/puller mechanism comprises at one spring operatively attached to said item engaging pusher/puller member for biasing and retracting said item engaging pusher/puller member towards said rest position.

4. The picking assist mechanism in accordance with claim 1, wherein said handle is elongated and fits flush with respect to a front end beam of said tier.

5. A tier for a storage facility comprising forward and rear end beams braced by vertical bracing members, a flow surface disposed between said front and rear end beams, respectively, for housing and delivering items to a front portion of said tier where they can be picked, said tier further comprising:
an item engaging pusher/puller member for forwardly forcing items disposed upon said flow surface at a rear portion of said tier towards said front portion of said tier, where they can be picked;
a pair of flexible connectors;
a manually operated handle disposed adjacent to said front portion and operatively attached to said item engaging pusher/puller member via said pair of flexible connectors, said handle pulling said item engaging pusher/puller member into engaging contact with an item/package disposed upon said flow surface, and forcing said item/package to said front portion of said tier.

6. The tier for a storage facility in accordance with claim 5, wherein said item engaging pusher comprises a movable pusher plate disposed along said flow surface of said tier for engaging with, and forcing, items disposed on a rear portion of said flow surface into moving forwardly toward said front tier portion.

7. The tier storage facility in accordance with claim 5, further comprising at least one spring member operatively attached to said pusher/puller member for biasing said pusher/puller member to a rest position.

8. The tier storage facility in accordance with claim 7, wherein said at least one spring member further comprises a spring reel disposed between the item/package engaging pusher/puller member and said rear end beam of said tier.

9. The tier for a storage facility in accordance with claim 5, wherein said handle is elongated and fits substantially flush or recessed within a forward end beam of said tier.

10. A picking assist mechanism for storage facilities comprising a tier having a flow surface disposed between and supported upon rear and forward end beams for housing and delivering items to a front picking area, comprising:
an item engaging pusher/puller member for forcing items disposed upon said flow surface at a rear portion of said tier to move forwardly towards said front picking area;
a flexible pull connector supported by said forward end beam of said tier, said pull connector operatively, and flexibly attached, to said item engaging pusher/puller member, and being operative to force said item/package engaging pusher/puller member to move forwardly upon said tier and approach said picking area when pulled, whereby said items are forced forwardly upon said flow surface to said front picking area; and
a biasing mechanism operatively attached to said item engaging pusher/puller member in order to retract said item/packaging engaging pusher/puller member from said engagement with said item/package, and its proximity to said front picking area.

11. The picking assist mechanism for storage facilities in accordance with claim 10, wherein said flexible pull connector further comprises a pair of flexible cables, and an elongated handle movably mounted upon said forward end beam and attached to said item/package engaging pusher/puller member by said pair of flexible connectors.

12. The picking assist mechanism for storage facilities in accordance with claim 11, where said biasing mechanism comprises a spring reel attached to a rear end beam on one end thereof, and attached to said item/package engaging pusher/puller member via an extendable flexible cable stored therein.

13. The picking assist mechanism for storage facilities in accordance with claim 11, further comprising a pair of guide rods disposed on juxtaposed sides of the flow surface, for guiding movement of said item/package engaging pusher/puller member.

14. The picking assist mechanism for storage facilities in accordance with claim 13, further comprising a pair of ball races disposed about said guide rods that engage said item/package engaging pusher/puller member, said ball races providing smooth movement of said item/package engaging pusher/puller member about said flow surface.

15. The picking assist mechanism for storage facilities in accordance with claim 11, wherein said biasing mechanism comprises at least one spring operatively connected to said pusher/pull member for biasing said pusher/pull member towards a rest position.

16. An ergonomic assist device for providing package or item movement upon a storage and delivery tier of a warehouse or storage facility, said ergonomic assist device comprising a manually operated pusher/puller member, which is movable upon said storage and delivery tier from a rest position to an operative position, said manually operative pusher/puller member being disposed in a rear portion of said storage and delivery tier in its rest position, and being disposed at a forward picking position upon said storage and delivery tier in its operative position, said ergonomic assist device operative to move generally inaccessible packages or items from within the tier towards said forward picking position, said ergonomic assist device comprising at least one flexible connector attached to the pusher/puller member, and a handle attached to the at least one flexible connector for pulling the pusher/puller member, said handle being operative to pull upon the at least one flexible connector in any direction with respect to said forward picking position.

17. The ergonomic assist device of claim 16, further comprising at least one spring operatively attached to said pusher/pull member for retracting said pusher/pull member to said rest position.

18. The ergonomic assist device of claim 17 further comprising guide rails supporting said pusher/puller member for movement from said rest position.

19. The ergonomic assist device of claim 16, further comprising a spring reel for retracting said pusher/pull member.

20. The ergonomic assist device of claim 18, further comprising a spring for retracting said pusher/pull member upon said guide rods towards said rest position.
